(19) United States
(12) Patent Application Publication
(10) Pub. No.: US 2011/0019938 A1
(43) Pub. Date: Jan. 27, 2011

(54) Paper shopper or bag and system for the production thereof

(75) Inventor: Fernando Giacometti, Vigonza (IT)

Correspondence Address: Themis Law, 7979 Ivanhoe Ave Ste 400, La Jolla, CA, 92037, US

(73) Assignee: J.W.T. SNC DI GIACOMETTI STEFANO & ZANON WALTER, Peraga di Vigonza (PD) (IT)

(21) Appl. No.: 12/922,446

(22) PCT Filed: Apr. 1, 2008
(86) PCT No.: PCT/IT2008/000214

§ 371 Date: Sep. 27, 2010

(51) Int. Cl. B65D 33/08; B65D 30/10; B31B 1/16; B31B 1/86; B31B 33/00

(52) U.S. Cl. 383/10; 383/20; 493/210; 493/221; 493/226; 493/240; 493/243; 493/264

(57) ABSTRACT

The invention concerns a new paper shopper or bag (B) and a system for the manufacture thereof, said bag comprising a folded and glued sheet (P), two handles (M, N) placed in proximity to two opposite edges (F1) of said sheet (P), forming the upper edges (B1) of said bag (B), said sheet (P) being folded along at least one line (A), transversal to the longitudinal axis (Bx) joining said handles (M, N), said line (A) forming the continuous and jointless bottom (B3), and wherein the lateral edges (F2) of said sheet (P) are coupled in such a way as to obtain the two vertical closed sides (B4) of the bag (B). Said system comprises a station (1) for unwinding a continuous sheet (F) according to an advance direction (X), and each bag (B), before the cutting operation (11) that separates the individual bags, is arranged with its main longitudinal axis (Bx) placed transversally with respect to said advance direction (X).

The present patent concerns the sector of paper bags commonly called shoppers and in particular it concerns a new type of paper shopper or bag with jointless and continuous bottom and the system developed for the production thereof

In recent years the production of paper bags has met with inscoring interest in the whole world. In the European Community, in particular, starting from Jan. 1, 2010, when the traditional plastic bags are ruled out, the market of plastic bags will probably receive great impulse.

At present, the diffusion and use of paper bags as shoppers is strongly limited and this is mainly ascribable to two reasons, that is, the production costs and the ecological compatibility of these bags.

Apart from the intrinsic cost of the raw material, production speed strongly affects the price of paper bags. In order to be able to understand what may hinder any increase in the speed of the production process of paper bags of known type, it is necessary to analyze the present production process.

At present, the process of manufacture of a paper bag is divided in the following three main subprocesses:

making of the handle;

making of the real bag;

application of the handle to said bag.

Here below is a brief description of the operating steps in which the above subprocesses are divided:

Handle Production and Application Subprocess

Unwinding of one or more paper strip and/or cord reels;

production, by a hot glueing process, of a continuous handle form, that is, a continuous form from which the individual handles will successively be cut;

cutting of the individual handles;

transport and immediate application of the handles to the continuous sheet with which the bag will be made.

Bag Production Subprocess

Unwinding of the continuous paper sheet wound in a reel;

application of the handle;

longitudinal folding and lateral hot melt glueing;

cutting of individual bags that are not yet formed;

bag bottom scoring;

opening of edges for the bag bottom;

application of vinyl glue for the bag bottom;

folding and closing of the bag bottom;

placing of the bag on the collection table;

manual packaging.

In the above list of operating stages it is possible to identify two critical moments that do not allow given operating speeds to be exceeded, or at least do not allow these speeds to be exceeded without affecting the reliability of the process itself.

In particular, said operations are the application of the handles and the folding and creation of the bag bottom.

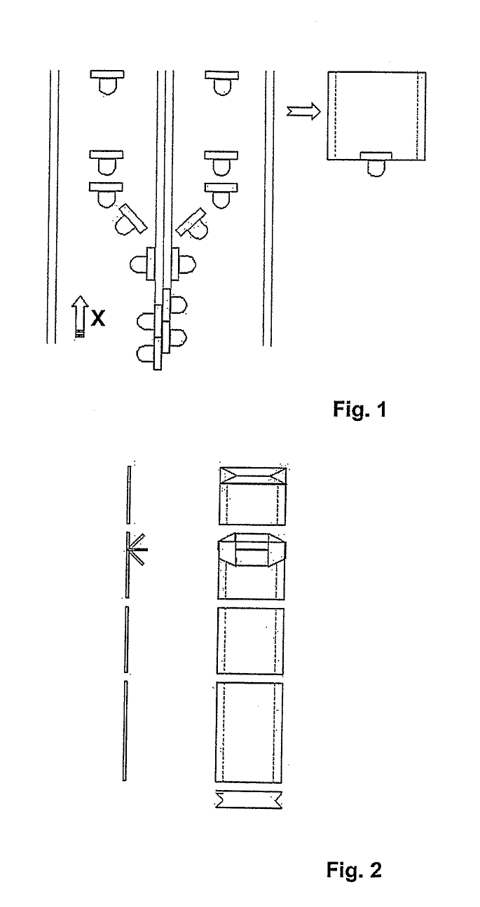

As far as the application of the handle is concerned, with reference to the diagram shown in FIG. 1, the corresponding station, called “handle making station” is understandingly complex from a mechanical point of view, due to the fact that it is necessary to cut, transport and directly attach each individual handle. The risk of a single handle becoming detached increases exponentially with the increase of the speed, and the, damage deriving from the loss of a single handle doesn't lie so much in the nonconformity of a single bag, but rather in the actual risk of the detached piece getting stuck in the mechanisms and causing dangerous clogging situations. This type of clogging, at best, may cause troublesome and prolonged machine stoppages, but sometimes they may also damage the mechanisms of the machine itself.

The process for making the bottom of the bags of known type takes place after the sheet has been folded longitudinally and after the sheet has been cut to separate the individual bags.

At this moment the sheet is not continuous any longer and any operation must be carried out with the need to stop and move the bags that haven't been formed yet, which is per se a complicating aspect.

To create the bottom, as is schematically shown in FIG. 2, first of all it is necessary to lift the upper edge of the already folded and cut bag. This operation is performed through suction and is characterized by physical speed limits that, among other things, depend even on the type of paper used.

Also in this case, failure to open the upper edge of the bag may cause serious clogging that in turn may cause machine stoppages and in some instances may also damage the most delicate mechanical parts of the bag machine.

Regarding the ecological compatibility of the paper bags of known type, as already explained in the introduction to this document, the Environment Committee of the Chamber of Deputies has approved an amendment to the financial act that forbids the sale of non-biodegradable bags starting from Jan. 1, 2010.

This amendment makes reference to the harmonised Standard EN 13432, valid in the entire European Union, which sets forth the biodegradability criteria for plastic of vegetable origin. It has been estimated that only in Italy about 300 thousand tons of polyethylene bags are produced, which correspond to 430 thousand tons of oil, with CO₂ emissions in the atmosphere of approximately 200 thousand tons.

This provisions would be useful to reduce the above mentioned consumptions and emissions.

According to the European Standard EN13432, the characteristics a compostable material must show are the following:

biodegradability, which is determined by measuring the actual metabolic conversion of the compostable material into carbon dioxide. This property can be measured with a test method provided by the EN14046 (also published as ISO 14855: biodegradability under controlled composting conditions). The acceptable biodegradation level is 90%, which must be reached in less than 6 months.

Disintegrability, namely fragmentation and loss of visibility in the final compost (absence of visual pollution). This is measured with a composting test (EN14045). The test material is composted with biowaste for 3 months. Once this time has elapsed, the final compost is screened with a 2 mm sieve. The test material residues whose size exceeds 2 mm are considered as if they were not disintegrable. This part must be less than 10% of the original mass.

Absence of negative effects on the composting process. This is verified with a composting test.

Low levels of heavy metals, below given maximum values, and absence of negative effects on the quality of the final compost, for example reduction of the agronomic value and presence of ecotoxicological effects on the growth of plants. A plant growth test (modified OECD 208) is carried out on compost samples where degradation of the test material has taken place. When verifying the compost, no difference should be observed. Other physical-chemical parameters that after composting must not be different from those of the reference compost are pH, salinity, volatile solids, N, P, Mg, K.

Each one of these points is needed for the definition of compostability, but one point alone is not sufficient.

Paper is, by definition, the main component of a paper shopper or bag. In the verification of the effective “compostability” of the entire product in question, the following is to be considered:

any colouring agents;

the material of which the cord, if present, is made;

any accessories or inserts made of materials different from paper;

and above all the bonding agents used for making the bag.

The first three items aren't intrinsecally connected to the bag manufacturing process, as the choice of more or less ecological materials doesn't affect, or affects only slightly, the mechanical process.

The bonding agents, on the contrary, have a strong influence on the mechanical manufacturing process and affect above all the disintegrability of the finished product.

In the manufacture of the paper bags of known type two types of glues are mainly used, that is, vinyl-based glues or hot melt glues.

Vinyl-based glues are soluble in water, set optimally on paper once dry and, owing to the fact that they are soluble in water, feature good disintegrability. On the other hand, they need a considerable setting time, which sometimes can be incompatible with some mechanical operations.

Hot melt glues aren't soluble in water and their main characteristic lies in that the resinous substance of which they are composed is in the solid state at ambient temperature. This means that in order to be able to use them it is first necessary to bring them to the melting temperature, over 150° C., and then, once they have been spread in the liquid state on the object to be glued, setting is almost immediate and coincides with the cooling of the substance below the melting point.

The negative aspect of this glue is represented by the fact that it features a very low level of disintegrability, in fact the glue lines used for the joints resist to maceration for times that are much longer than paper fragmentation times.

Notwithstanding the low ecological compatibility of hot melt glues, these continue to be used because they are necessary in the presently known processes adopted for manufacturing paper bags.

In the manufacture of paper shoppers or bags of known type, the hot melt glue is substantially used in two phases, that is, for making the handles through a continuous glueing cycle, and in the longitudinal folding and lateral glueing of the continuous paper sheets.

The stage immediately successive to the two stages described above consists in the transversal cutting of the handle form into individual handles and of the folded sheet into individual bags not completely formed.

When treating a detached object, like the handle or the bag with the still open bottom, immediate and complete setting, which only hot melt glues can ensure, is indispensable.

The operations described above are of fundamental importance for making paper bags of the traditional type and they cannot be eliminated, therefore at present it is very difficult to replace hot melt glue with another type of glue. In the manufacture of the paper bags presently available on the market, even if it were physically possible to exceed certain speed limits, the complexity of some operations would in any case require that certain practical safety thresholds be not exceeded.

In particular, practice has shown that all the operations carried out after interruption of the continuous form of product, for example the management of the individual handles, the making of the bottom, ecc, result to be much more complex than those carried out when the continuous form of product has not been interrupted yet, for example the longitudinal folding and the longitudinal glueing of the bag, the creation of the continuous form of handles, ecc.

Furthermore, said operations carried out after interruption of the continuous form of product absolutely need a quick setting but scarcely ecological bonding agent like hot melt glue.

At this point, the indispensable premise in the search for increased productivity and environmental friendliness of paper bags is the determination of a process according to which the continuous form is interrupted as late as possible.

In the case where the main cutting of the continuous forms of bags and handles were the last operation to be carried out before the end of the process, the constraints represented by the speed and the use of the hot melt glue mentioned above would disappear.

The solution of the problem described above can be reached by observing how, for the paper bags used at present, it is not possible to define a manufacturing process according to which physical separation, and therefore interruption of the continuous form, is the last operation carried out.

Therefore, it is necessary to devise a new product that allows the main cutting operation to be performed only at the end of the manufacture of the entire paper bag.

Consequently, a new type of paper shopper or bag has been designed and manufactured, with continuous one-piece bottom and glued lateral edges, together with a system for the manufacture thereof, where said paper shopper or bag is arranged on the production line with its main longitudinal axis in a position substantially orthogonal to the advance direction.

The main object of the new paper shopper or bag is to have lower production costs than the paper bags of known type, thanks to the fact that it can be manufactured on a continuous production line, thus maximizing production speed and reducing the relative costs.

Another important object of the present invention is to guarantee the required sturdiness, in particular as concerns the bottom that, being continuous and without joints, can bear greater loads compared to the paper bags of known type, which on the contrary have a folded and glued bottom.

Another important object of the present invention is to guarantee compliance with ecological compatibility requirements, since no slowly biodegradable or disintegrable substances, like hot melt glue, are used.

The main object of the present invention is to increase production speed, by interrupting the continuous form only in the final stage, when the main transversal cutting operation is performed.

Another important object of the present invention is to optimize production times and costs, since it is possible to use the paper rolls used at present, producing a double row of bags that are then separated by a longitudinal cut or die cut parallel to the direction of advance on the production line.

These and others direct and complementary objects are achieved by the new type of paper shopper or bag with continuous jointless bottom and glued lateral edges. For the manufacture of said shopper or bag a system has been designed and implemented according to which said paper shopper or bag is arranged on the production line with its main longitudinal axis in a position substantially orthogonal to the direction of advance.

The new paper shopper or bag comprises at least one folded sheet, where the bottom is continuous and jointless, being defined by the folds of the sheet along at least one intermediate transversal line.

The lateral edges of the sheet, on the contrary, are glued and if necessary folded, for example in the shape of bellows, to define the sides of the bag. Therefore, differently from the paper bags of known type, whose bottom is obtained by folding and glueing the edges of the sheet, the new paper bag has sides obtained by glueing but a continuous and jointless bottom, capable of supporting greater loads than the paper bags of known type having an open bottom that has been successively glued.

The new bag also comprises a pair of handles positioned on the edges of the folded sheet and defining the open top of the bag.

Said handles can be of the so-called “bean” type, that is, they can be obtained by directly cutting to elongated holes in corresponding positions in the two upper opposite edges of the folded sheet, or of the so-called “cord” type, that is, of the type comprising each a cord or strip, in paper of fabric, applied to the upper edges of the bag to form a grip.

In the preferred embodiment of the invention, said upper edges comprise a reinforcement strip or band, in paper or cardboard, applied internally or externally to the folded sheet making up the bag, and wherein said handles, of the “bean” type, are obtained by cutting said holes at the level of said reinforcement strip applied to the sheet.

Said upper edges can be rectilinear or shaped, for example substantially convex.

According to a further embodiment of the invention, the upper edges of the bag can be folded one or more times to reinforce the handle.

According to another embodiment of the invention, the new bag comprises two handles of the “cord” type as an alternative to the “bean” type, wherein each handle comprises at least one cord or strip, for example made of paper, with ends fixed to said edge of the bag, for example interposed between said sheet and reinforcement strip joined to each other.

In the system for the manufacture of said new bag (B), it is arranged on the production line with its main longitudinal axis (Bx) in a direction substantially orthogonal to the direction of advance (X) of the production line, wherein said main longitudinal axis (Bx) is the straight line joining the bottom of the bag to the open top of the bag.

On the contrary, in the production systems of known type the paper bags are produced with their main longitudinal axis in a direction substantially parallel to the development direction of the production line.

In this way, instead, a bag with jointless bottom and thus capable of bearing heavier loads is obtained, and furthermore all the stages in the manufacture of the bag itself can be carried out continuously, since the transversal cutting operation is carried out only at the end of the production line.

The characteristics of the new bag and of the system for the manufacture thereof will be highlighted in greater detail in the following description with reference to the drawings that are attached as non-limiting examples.

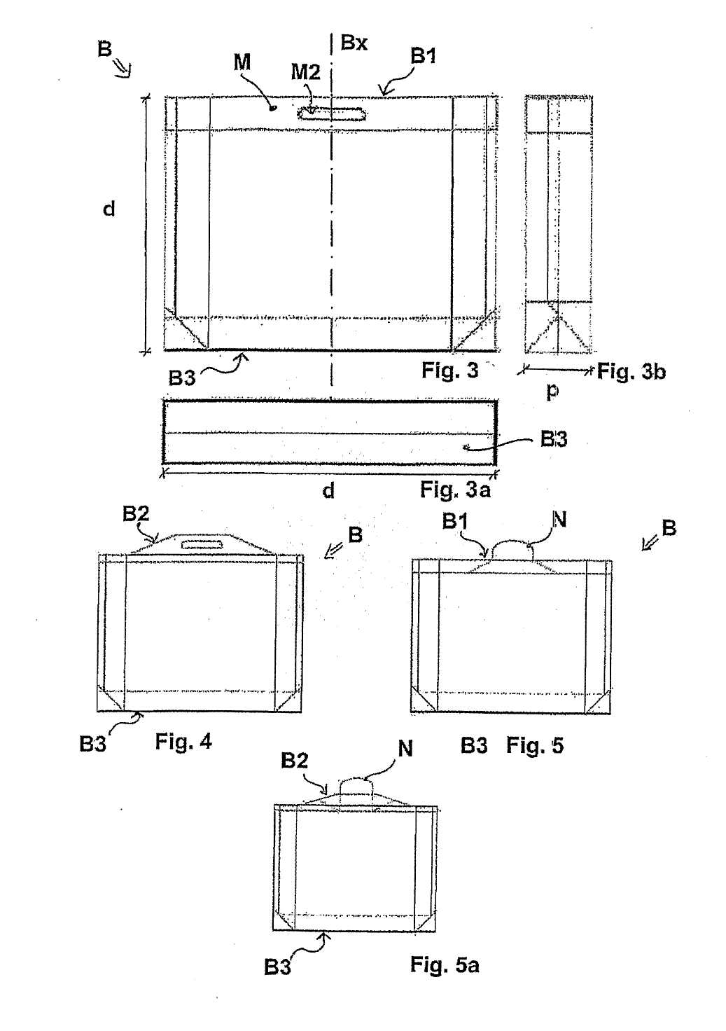

FIGS. 3, 3a, 3b show orthogonal projections of the new bag (B) with “bean” handle (M), rectilinear upper edge (B1) and bellows-shaped bottom (B³).

FIGS. 4, 5 and 5a respectively show three further possible embodiments of the new bag (B), with “bean” handle (M), substantially arched upper edge (B2) and bellows-shaped bottom (B3) (FIG. 4), with cord handle (N), rectilinear upper edge (B1) and bellows-shaped bottom (B3) (FIG. 5), with cord handle (N), substantially arched upper edge (B2) and bellows-shaped bottom (B3).

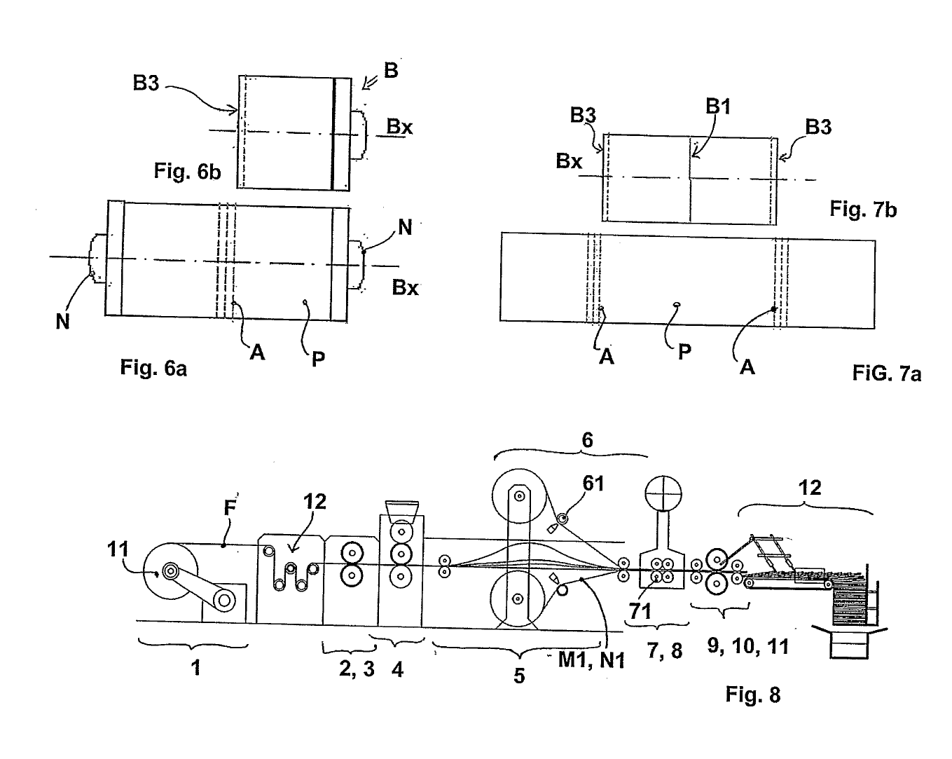

As schematically shown in FIGS. 6a and 6b, the new bag (B) is obtained by folding a substantially rectangular sheet (P) along scores or folding lines (A) that are orthogonal to the main longitudinal axis (Bx) of the bag (B), defining the jointless bottom (B3) of the bag (B), with or without bellows. The sheet (P) is then glued and if necessary folded along the lateral edges (F2) to define the sides (B4) of the bag (B), with or without bellows.

As schematically shown in FIGS. 7a and 7b, it is possible to obtain two bags (B) from each sheet (P), creating two parallel folds or series of folds (A). In this way, the two opposite edges (F1) of the sheet (P) will converge and join at the centre of the sheet (P) itself. The upper edges (B1) of each one of the two bags (B) still joined, as shown in FIG. 7b, will be located along the median axis of the sheet (P), orthogonally to the vertical longitudinal axis (Bx) of the bag (B).

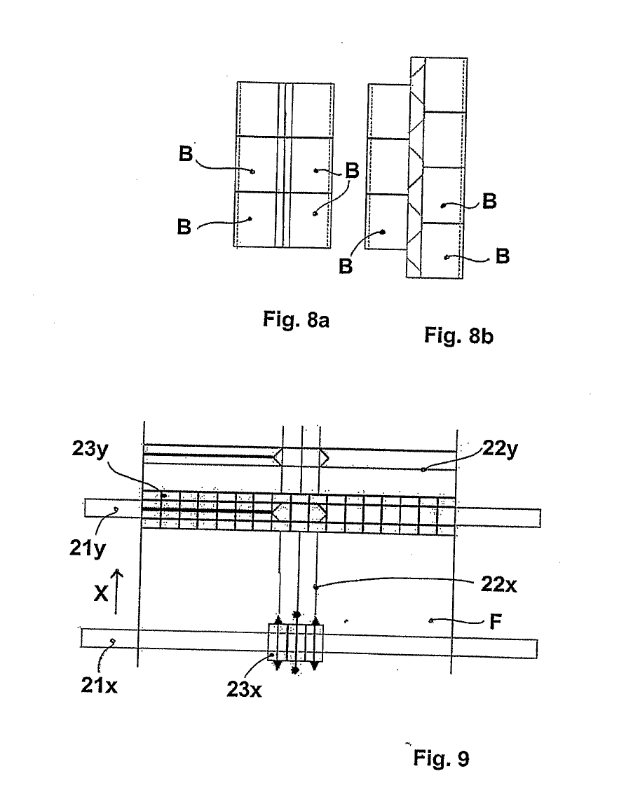

FIG. 8 schematically shows a side view of the new system for manufacturing the new paper bag (B), while FIGS. 9-17 are schematic representations of the individual manufacturing stages.

All the stages and operations necessary for completing the bag (B), except for the stacking stage (12) of the finished bags (B), are carried out working on continuous forms, that is, the continuous sheet (F) and the handle form (M, N) that are not subjected to cutting operations transversal to the advance direction (X) until the final transversal cutting (11).

For example, as far as the handle form (M, N) is concerned, both for the “bean” handle (M) and for the cord handle (N), this can be coupled to the continuous sheet (F) with no need for any separation.

As to said continuous form (F), each processing stage for the manufacture of the bag (B) can be carried out before the final transversal cutting (11). These processing stages are the following:

scoring (2) for the successive folding operations (FIG. 9);

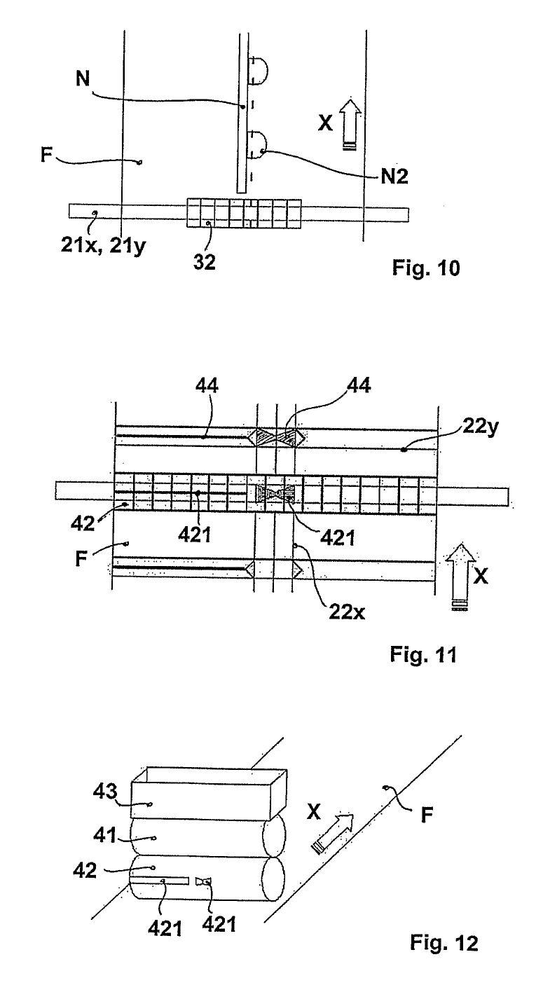

any pre-cuts (3) for the successive separation of the finished product (FIG. 10);

spreading of the vinyl glue (4) on the areas where the handle forms (M, N) will be glued and where the lateral edges will be joined to form the sides (B4) of the bag (B) (FIGS. 11, 12);

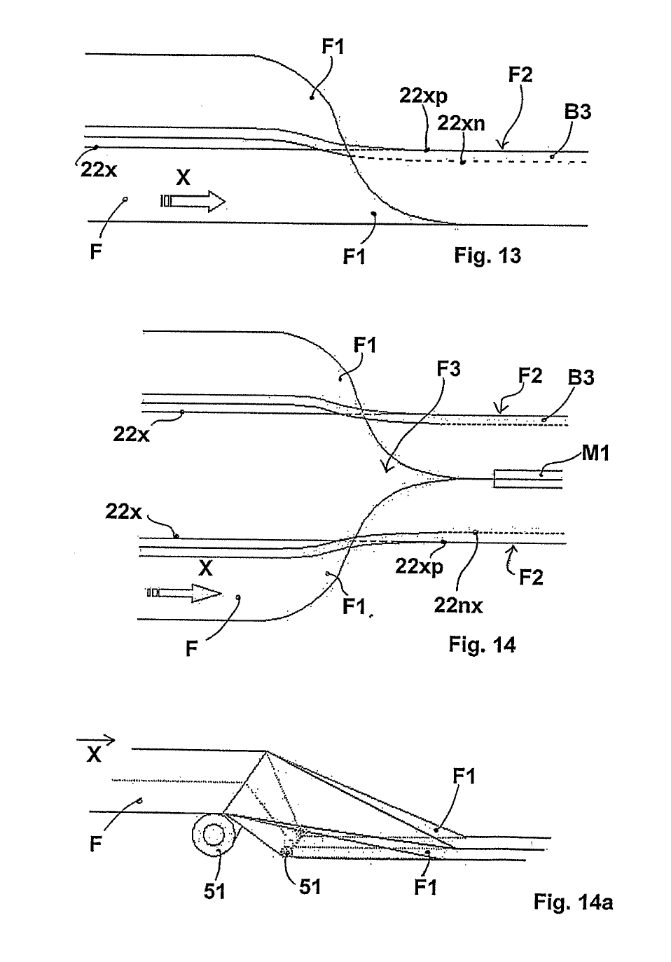

folding (5) in longitudinal direction, that is, parallel to the advance direction (X), to define the closed bottom (B3) of the bags (B) (FIGS. 13, 14, 14a, 15, 16a, 16b);

coupling (6) of the handle forms (M, N) to the continuous sheet (F), said handle forms (M, N) comprising one or more paper or cardboard strips (M1, N1), with or without cord (N2), arranged in longitudinal direction, that is, parallel to the advance direction (X) at the level of the area where the handles (M, N) of the bag (B) will be made;

glueing (7) of the two lateral folded edges (F1) of the sheet (F) at the level of said areas to which the vinyl glue had been applied;

if necessary, heating (8) with hot air to accelerate the glueing stage;

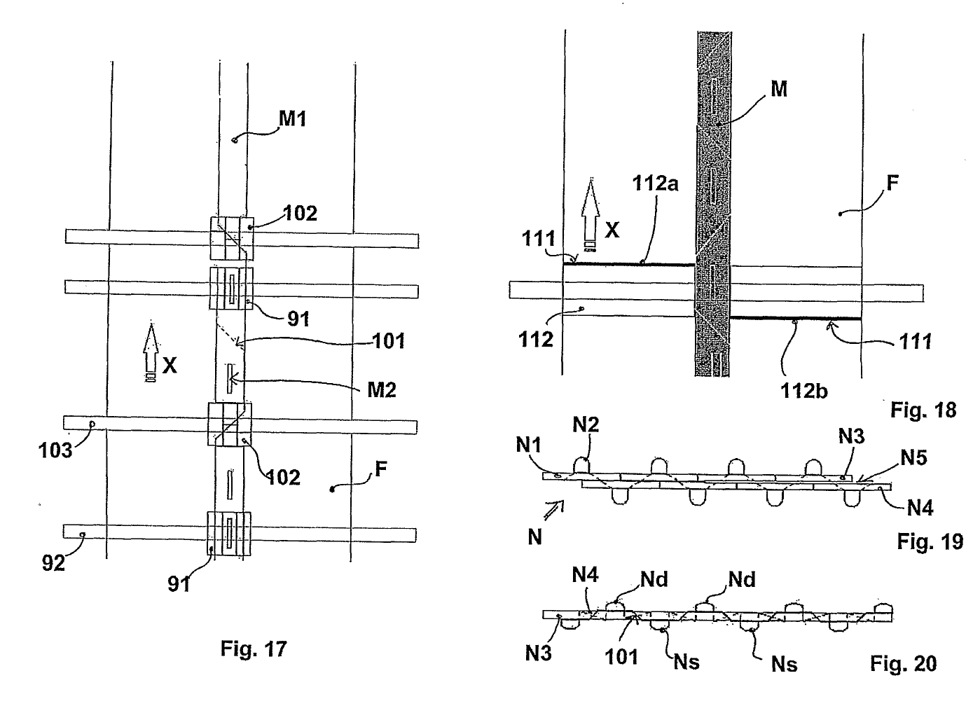

if necessary, die cutting (9) of the “bean” handle (M) and longitudinal cutting or die cutting (10) in the case of a double row of bags (B) (FIG. 17).

According to the invention, it is possible to create two parallel rows of bags (B) for each continuous sheet (F), creating two double longitudinal and parallel scores or series of scores (22).

Said two rows of bags (B) can be aligned, or “synchronous”, or staggered, as respectively illustrated in FIGS. 8a and 8b.

The system comprises at least one roller or reel holder (11) for unwinding (1) the continuous paper sheet (F). Said roller holder (11), for example, is of the type for continuous, 2500 mm wide sheets (F), which make it possible to produce bags (B) with a height (h) of 550 mm, and having a rectangular basis whose shorter side or depth (d) measures 150 mm and whose longer side (d) is defined by the distance between two final transversal cuts (111). The paper tension will be adjusted by means of at least one pneumatic braking device and one or more load cells (12) positioned immediately downstream of the roller holder (11).

The scoring stage (2), schematically represented also in FIG. 9, takes place successively.

Said scoring stage (2) is necessary in order to allow the flattened bag (B), obtained at the end of the manufacturing process, to easily assume its characteristic three-dimensional shape.

Said scores (22x, 22y), respectively parallel (22x) and orthogonal (22y) to the advance direction (X), will be achieved by means of one or more shafts (21x, 21y) controlled by an electric axis. To obtain different depths (p) of the bag (B), it will thus be sufficient to replace only the scoring tools (23x, 23y) and modify the settings of the electric axis.

In the case where the cord handle (N) must be applied, after unwinding (1) of the reel (F) the pre-cutting (3) of the sheet may also be carried out, as schematically represented and exemplified in FIG. 10, which consists of one or more cuts (31) made in the sheet (F), in the area where the cord (N2) of the handle (N) will be successively applied. The pre-cut is carried out in order to prevent the blade used for the longitudinal cutting or die cutting (10) from cutting also the cord (N2).

As for the scoring (2), even the pre-cuts (3) will be carried out by one or more shafts (21x, 21y) controlled via an electric axis. In some cases, the precutting tools (32) can be mounted on the scoring shafts (21x, 21y) themselves.

Before the longitudinal folding operation (5), vinyl glue (4) must be spread on the areas of the sheet (F) that will make up the lateral closing edges of each bag (B), as is schematically illustrated in FIGS. 11 and 12.

The glue spreading operation (4) is carried out by means of two cylinders, an upper cylinder and a lower cylinder (41, 42), and a tank (43) for depositing the glue on said upper cylinder (41).

Said upper cylinder (41) revolves around its longitudinal axis and brings with itself a layer of glue removing it from the tank (43), then it rotates by another portion of revolution in contact with the lower cylinder (42) and deposits said vinyl glue on the impressions (421) present on the lower cylinder (42). The latter, via an electric axis, will dynamically deposit, by contact, the correct layer of glue (44) in the correct position on the sheet (F). As in the case of the scoring (2) and pre-cutting (3) stages, even for the glue spreading stage (4) interchangeable impression tools (421) will be used to comfortably pass from one format to the other.

After the vinyl glue has been spread (4), the continuous sheet (F) must be folded longitudinally, that is, parallel to the direction (X) of advance of the sheet itself.

The longitudinal folding (5) is carried out by means of a series of baffles (51) with progressive angle and suitable inclination between the non-folded and the folded sheet (F), for example using a cylinder and rubber wheels, as shown and exemplified in FIG. 14a.

After scoring (5), the external edge (F2) of the folded sheet (F) will make up the bottom (B3) of the bag (B).

As schematically shown in FIGS. 13 and 14, respectively for a single or double production line, the depth (p) or minimum dimension of the bottom (B3) of the bag (B) is determined by the distance between the longitudinal scores (22x) previously made, which create a bottom (B3) that can be in the shape of bellows or not.

The folding of the bellows, if present, will be carried out by means of idle wheels with decreasing thickness, not represented in the figure, along said longitudinal scores (22x), where the positive scores (22xp) are represented by a continuous line while the negative scores (22xn) are represented by a broken line.

FIG. 13 represents, in particular, only the longitudinal folding stage (5) for a single production line. One of the lateral edges (F1) of the sheet (F) is lifted, rotated by 180° and placed over the opposite lateral edge (F1). The bellows, if present, is obtained from the longitudinal scores (22x) previously made.

FIG. 14 represents, in particular, only the longitudinal folding stage (5) for a double production line.

In this case both the opposite lateral edges (F1) of the sheet (F) are lifted, rotated by 180° towards the centre, placed side by side and laid over the central portion (F3) of the sheet (F).

The two external edges (F2) of the sheet (F) will thus define the bottoms (B3) of the two rows of bags (B) being manufactured.

According to a first embodiment represented in FIG. 14, the joint between said edges (F1) placed side by side at the centre (F3) is carried out by applying (6) externally the handle form (M), comprising a strip of paper or cardboard (M1) that also serves to cover the joint. The bellows are also created, following longitudinal scores (22x) made previously.

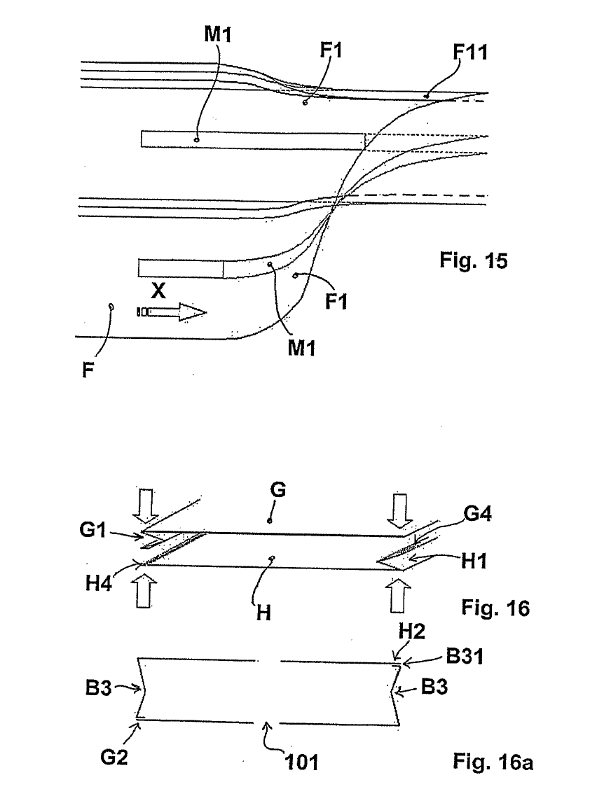

According to a further possible embodiment schematically illustrated in FIG. 15, as an alternative to said external application (6) of the handle form (M) after the folding stage (5), the handle form (M) is applied before the folding stage (5) on the inner side of the sheet (F), that is, on the side that will not be in sight.

The edge of the side (F1) where the joint will be made is lifted and folded for a few centimetres (F11), a continuous layer of glue is deposited thereon, the opposite edge (F1) is lifted and rotated by 180° until the two edges overlap completely and are glued together.

In this case, the internal application of the handle form/s must be carried out before the longitudinal folding stage (5) and the forms are applied in a substantially intermediate position on the folded sheet (F), parallel to the advance direction (X).

The handle forms (M, N) are therefore continuous.

According to a first possible embodiment, said handle forms (M) comprise at least one strip or band made of paper or cardboard (M1), and allow handles of the so-called “bean” type to be obtained, as shown in FIGS. 3, 4, 14,17, 18.

According to a possible further embodiment, said handle forms (N) comprise at least one strip or band made of paper or cardboard (N1) with a cord (N2) folded and coupled to said strip (N1), suited to make up the grip of said bag, thus allowing handles of the so-called “cord” type (N) to be obtained, as shown in FIGS. 5, 5a, 19, 20.

Said handle forms (M, N) are called continuous as their coupling to the continuous sheet (F) takes place with no need to interrupt them, for example by cutting them transversally with respect to the advance direction (X).

In the case of “bean” handles (M), the form (M) comprises at least one reinforcement strip (M1) made of paper or cardboard, wherein the bean-shaped opening, or elongated hole (M2) will be made during the die cutting stage (9), after the folding (5) and glueing (7) stages, but before the final tranversal cutting (11) by means of at least one rotary die cut (81).

In the case of cord handles (N), the handle form is obtained by sandwiching the cord (N2) between two or more paper strips or bands (N1), said cord (N2) being properly folded to obtain a sort of decoration, with a series of Us alternately projecting from the two sides of said strips (N1).

In the case of bags produced on a single production line, the final handle forms (N3, N4) will be obtained by cutting longitudinally (5), in intermediate position, a primitive form (N), as shown in FIG. 19.

In the case of bags produced on a double production line, staggered, it will be necessary to generate two separate overlapping forms (N3, N4), each one of which will alternately provide one handle (Nd) for the bags (B) of the first row and one handle (Ns) for the bags (B) of the second row, as shown in FIG. 20.

The longitudinal cutting or die cutting line (101) that separates the handles (Nd, Ns) of the two rows is the same line (101) that separates the continuous folded sheet (F).

The longitudinal cutting or die cutting (10) is obtained by means of at least one rotary die cut (102), before the final transversal cut (11).

In this type of production, the pre-cutting operation (3) previously described will be adopted, in order to protect the cords (N2) of the handle (N) during the successive longitudinal die cutting (10) and final transversal cutting (11) stages.

In the case of production of a double row of bags (B) in a mirror-like configuration, cord handles are not used due to their complexity.

When, because of aesthetical or construction reasons, the handle forms (M, N) should be applied in sight, that is, externally to the bag, the coupling will be carried out after the longitudinal folding stage (5) for closing the bags, as shown for example in FIG. 14.

When, on the contrary, the handle form (M, N) isn't applied in sight, it must be coupled and fixed to the sheet (F) before the longitudinal folding stage (5), as shown in FIG. 15.

Thus, depending on the handle forms (M, N) and on the way in which they are applied, a suitable layer of quick setting vinyl glue (61) is spread directly onto the strip or band of paper or cardboard (M, N) to be applied to the sheet (F), as shown in FIG. 8.

As in the case of the coupling of the handle forms (M, N), beyond certain speeds the quick fixing of the sheet (F) folded along the lateral joints will be a considerable problem.

To guarantee the rapid adhesion of the handle form (M, N) and also of the sheet (F) along said lateral joints, the invention requires the use of quick vinyl glue, subjected to prolonged compression by means of a suitable series of pressure rollers (71), while the area involved by the coupling is subjected to a heating process (8), if necessary.

Once the folded sheet (F) has been properly glued, the “bean” die cutting is carried out (9). In the case of a sheet (F) suitable for a double row of bags, the longitudinal die cutting for the separation of the rows is also carried out (10).

As in the case of said scores (2), the above mentioned “bean” die cutting (9) and longitudinal die cutting (10) are obtained by using interchangeable tools (91, 102) coupled to one or more shafts (92, 103) controlled by an electric axis, as schematically shown in FIG. 17.

The last operation, that makes it possible to obtain the finished bag, is the transversal cutting (11), that is, in a direction substantially transversal to the advance direction (X), which separates the bags (B) that have already been completed.

The transversal cutting (11), as schematically shown in FIG. 18, takes place by using at least one blade holding cylinder (112) with the blade coupled to a corresponding counter-blade, both controlled by an electric axis.

In the case of a double row, with staggered bags (B), the blade holding cylinder (112) will be provided with two half-blades (112a, 112b), one per each row, offset by 180°.

In the case of a double row, if it is not possible to use a single sheet due to dimensions, printing needs or technical requirements of the material used, two or more continuous sheets will be coupled, for example two continuous sheets (G, H) with halved width.

Said two continuous sheets (G, H) will be provided with the bellows-shaped folds (G1, H1) that form the jointless bottom (B3) of each bag (B), while the joint (G2, H2), as schematically shown in FIGS. 16 and 16a, is achieved by spreading quick setting vinyl glue (G4, H4) on one of the vertical walls of the bag (B), in proximity to the corner (B31) of the bottom (B3) so that:

the bottom (B3) remains jointless in any case;

the joint (G2, 112) overlaps the corner (B31) of the bottom (B3) and thus it is not visible.

The bags (B) are then obtained through the longitudinal separation cutting (10).

According to the invention, therefore, said continuous sheet (F) from which said shoppers or bags (B) are made is obtained by joining, for example through a glueing process, two or more sheets (G, H).

Furthermore, according to the invention, said sheet (F) or part of said sheet (F) can be coupled or in any case joined to one or more sheets made of a material different from paper, for example fabric in natural or Synthetic fibres or other types of material.

For example, said sheet (F) or part of said sheet (F) can be coupled to one or more further sheets made of a transparent or semi-transparent material.

In the bag machines presently available on the market, considered the practical speed limits, the aspect concerning automatic packaging is rarely examined in depth, and therefore after being positioned vertically side by side on a flat table, the bags produced are boxed only manually. On the contrary, in a production process where speed can considerably exceed the traditional values, stacking can be hardly managed by hand. And even worse, it cannot be managed by hand if it is considered that, with the double production line, the speed intended as number of pieces/hour must be multiplied by two.

Therefore, the new system also comprises a station for automatically stacking the bags and boxing them (12).

In the new system the bags (B) are thus produced by maintaining them with their main longitudinal axis (Bx) arranged orthogonally with respect to the advance direction (X).

In this way, as already explained, the manufacturing process is continuous up to the transversal cutting (11) that takes place at the end of the process itself, before the stacking station (12).

Therefore, the new system makes it possible to reach high production speeds and to eliminate the use of scarcely eco-compatible glues, and, finally, to produce economical and ecological bags.

Therefore, with reference to the above description and the attached drawings, the following claims are expressed.

What is claimed is:

1. Paper shopper or bag (B) comprising a folded and glued sheet (P), provided with two handles (M, N) positioned in proximity to the two opposite edges (F1) of said sheet (P), forming the upper edges (B1) of said bag (B), said sheet (P) being folded along at least one line (A), transversal to the longitudinal axis (Bx) joining said handles (M, N), said line (A) forming the continuous and jointless bottom (B3), characterized in that the lateral edges (F2′) of said sheet (P) are cut along a straight line and coupled with glue by simple and mutual overlapping, without turning over, to obtain the two vertical closed sides (B4) of the bag (B).

2. Paper shopper or bag (B) according to claim 1, characterized in that said bottom (B3) is folded to form a bellows towards the inside of the bag (B).

3. Paper shopper or bag (B) according to claim 1, characterized in that each one of said handles (M, N) is applied to the surface of said sheet (P) facing the inside of the bag (B).

4. Paper shopper or bag (B) according to claim 1, characterized in that said opposite edges (F1) defining the upper edges (B1) of the bag (B) are folded one or more times towards the inside and/or towards the outside in order to reinforce said handle (M, N).

5. Paper shopper or bag (B) according claim 1, characterized in that each one of said handles (M) comprises at least one reinforcing strip or band (M1), made of paper or cardboard, applied to said sheet (P) in proximity to the corresponding edge (F1).

6. Paper shopper or bag (B) according to claim 5, characterized in that it comprises holes (M2) in proximity to said upper edges (B1), suited to form the grip of the handles (M), being obtained by partial or complete cutting or folding or removal of at least one portion of said coupled sheet (P) and strip (M1).

7. Paper shopper or bag (B) according to claim 1, characterized in that each one of said handles (N) comprises at least one reinforcing strip or hand (N1), made of paper or cardboard, applied to said sheet (P) in proximity to the corresponding edge (F1), and wherein at least one cord (N2) is arranged, substantially in the shape of an upturned U, and with both ends interposed and constrained between said sheet and said reinforcement strip (N1) to form a grip.

8. Paper shopper or bag (B) according to claim 1, characterized in that said sheet (P) comprises two or more sheets (G, H) joined to each other.

9. Paper shopper or bag (B) according to claim 1, characterized in that said sheet (P) is joined or coupled to one or more sheets made of paper and/or plastic and/or a fabric of natural or synthetic fibres.

10. System for mass production of paper shoppers or bags (B), characterized in that it comprises:
at least one station (1) for unwinding at least one continuous sheet (F) in at least one advance direction (X);
at least one station (2) for scoring said continuous sheet (F) along at least one longitudinal score or series of scores (22x) parallel to the advance direction (X), defining the folding lines to obtain the jointless and closed bottom (B3) of at least one row of bags (B) joined at the sides;
at least one station (4) for the application of a bonding agent on the areas of said sheet (F) that will successively be joined to form the vertical closed sides (B4) of each bag (B);
at least one station (5) for folding said continuous sheet (F) along said scoring line/s (22x) parallel to said advance direction (X), and wherein the lateral edge (F1) of said sheet (F), which is lifted and folded on the sheet (F) itself, defines, with the opposite part of said sheet (F), the upper edges (B1) of the corresponding row of bags (B), while the opposite folded edge (F2) defines the bottoms (B3) of said row of bags (B);
at least one station (7) for coupling by glueing said folded sheet (F) along the areas corresponding to the vertical closed sides (B4) of each bag (B);
and wherein said stations (2, 4, 5, 7) are downstream of said unwinding station of said continuous sheet (F) and upstream of at least one station (11) for the transversal final cutting of said continuous folded sheet (F), in a direction transversal to said advance direction (X) and at modular distances, for the separation of each individual finished bag (B), and wherein each bag (B), before said sheet (F) is cut (11) to separate the individual bags, is arranged with its main longitudinal axis (Bx), joining the bottom (B3) of the bag (B) to the top of the bag (B) itself, positioned transversally with respect to said advance direction (X), said bag (B) being already completed, without needing any further operation for producing said bottom (B3) or said sides (B4).

11. System for the manufacture of paper bags (B) according to claim 10, characterized in that it comprises at least one automatic station (12) for stacking and boxing said bags (B), said station being positioned downstream of said transversal cutting station (11).

12. System for the manufacture of paper bags (B) according to claim 10, characterized in that it comprises:
at least one station (6) for applying one or more handle forms (M), each comprising at least one continuous reinforcement strip or band (M1) suited to be applied to said sheet (F) parallel to said advance direction (X) in proximity to said upper edges (B1) of each row of bags (B);
at least one station (8) for die cutting at least one series of elongated holes (M2) at modular distances, aligned along said reinforcement strip (M1) applied to said sheet (F), and wherein each hole (M2) defines the grip of a handle (M) of each bag (B),
and wherein said die cutting operation (8) takes place before the transversal cutting (11) that separates said bags (B).

13. System for the manufacture of paper bags (B) according to claim 10, characterized in that it comprises:
at least one station for making one or more handle forms (N), each handle form (N) comprising at least one pair of continuous reinforcement strips or bands (N1), between which at least one cord (N2) is interposed and constrained, said cord being folded to form a series of Us alternately projecting from one side and the other of said pair of coupled strips (N1), each U defining the grip of one handle (N) of each bag (B);
at least one station (6) for the application of said reinforcement strips (N1) to said sheet (F), parallel to said advance direction (X), in proximity to said upper edges (B1) of each row of bags (B).

14. System for the manufacture of paper bags (B) according to claim 10, characterized in that it comprises at least one station (4) for the application of a bonding agent on the areas of said sheet (F) where said handle forms (M, N) will be applied and/or on said handle forms (M, N) themselves.

15. System for the manufacture of paper bags (B) according to claim 10, characterized in that said bonding agent is a vinyl glue.

16. System for making paper bags (B) according to claim 10, characterized in that said scoring station (2) comprises means (2) for scoring said continuous sheet (F) along two longitudinal scores (22x) or series of scores (22x) parallel to the advance direction (X), respectively defining two folding lines or series of lines to obtain the jointless and closed bottoms (B3) of two parallel rows of bags (B), and wherein said bags (B) of each row are joined at the sides.

17. System for the manufacture of paper bags (B) according to claim 16, characterized in that said main longitudinal axis (Bx) of each bag (B) of one of said two rows coincides with the main longitudinal axis (Bx) of one bag (B) of said second row or with the transversal line that separates two adjacent bags (B) of said second row.

18. System for the manufacture of paper bags (B) according to claim 10, characterized in that said scoring station (2) comprises means for scoring said continuous sheet (F) along at least one score (22y) or series of scores (22y) transversal and/or oblique to the advance direction (X), defining folding lines suited to create the axis on the closed vertical sides (B4) of each bag (B)

19. System for the manufacture of paper bags (B) according to claim 10, characterized in that said scoring means (2) comprise one or more shafts (21x, 21y), controlled via an electric axis, with corresponding interchangeable scoring tools (23x, 23y) suited to create series of scores (22x, 22y) at predefined distances.

20. System for the manufacture of paper bags (B) according to claim 10, characterized in that said longitudinal folding station (5) comprises means (5) for the longitudinal folding of both the opposite lateral edges (F1) of the sheet (F), which are lifted and folded towards the central portion (F3) of the sheet (F) itself, where they are practically positioned side by side, each one defining an upper horizontal edge (B1) of the respective row of bags (B) joined laterally, while the opposite folded edges (F2) define the bottoms (B3) of the two rows of bags (B), and wherein one of said handle forms (M, N) is applied and glued to said sheet (F) at the level of said central portion (F3), covering the joint between said lateral opposite edges (F1) of the folded sheet (F).

21. System for the manufacture of paper bags (B) according to claim 20, characterized in that said longitudinal folding means (5) comprise one or more baffles (51) with progressive angle and suitable inclination and/or one or more idle wheels with decreasing thickness for the longitudinal folding (5) intended to form a bellows along said longitudinal scores (22x), positive (22xp) and negative (22xn).

22. System for the manufacture of paper bags (B) according to claim 10, characterized in that it comprises at least one further station for the longitudinal cutting or die cutting (10) of said two rows of bags (B) along at least one longitudinal line (101) separating said folded sheet (F) and said reinforcement strip (M1) or said pair of reinforcement strips (N1) with interposed cord (N2), and wherein said longitudinal cutting or die cutting station (10) is upstream of said transversal cutting station (11).

23. System for the manufacture of paper bags (B) according to claim 10, characterized in that it comprises one or more pressure rollers (71) and/or means (72) for heating at least the areas that are joined with vinyl glue.

24. System for the manufacture of paper bags (B) according to claim 10, characterized in that said station (4) for the application of vinyl glue comprises at least two overlapping parallel cylinders (41, 42) whose rotation is controlled via an electric axis, and a tank (43) for depositing the glue on said upper cylinder (41), and wherein said upper cylinder (41), rotating around its own longitudinal axis, brings with itself a layer of glue removing it from the tank (43), and then rotating further in contact with the lower cylinder (42) deposits said vinyl glue on impressions (421) present on said lower cylinder (42) suited to dynamically deposit, by contact, a layer of glue on said sheet (F).

25. System for the manufacture of paper bags (B) according to claim 24, characterized in that said impressions (421) of said lower cylinder (42) are interchangeable.

26. System for the manufacture of paper bags (B) according to claim 10, characterized in that it comprises:
at least one station (1) for unwinding two continuous sheets (G, H);
at least one longitudinal folding station (5) for making bellows-shaped folds (G1, H1) on one or both the edges of at least one sheet (G, H), which will make up the jointless bottom (B3) of each bag (B);
at least one station (4) for the application of vinyl glue along the edges of said sheets (G, H);
at least one station for coupling said overlapping sheets (G, H) and wherein the joint (G2, H2) of said sheets (G, H) is obtained on one of the vertical walls of the bag (B), in proximity to the corner (B31) of the jointless bottom (B3);
at least one intermediate longitudinal cutting station (10) for separating the two opposing rows of bags (B).

27. System for the manufacture of paper bags (B) according to claim 10, characterized in that said transversal cutting means (11) comprise at least one blade holder cylinder (112) with at least one blade coupled to a corresponding counter-blade, both controlled by an electric axis.

28. System for the manufacture of paper bags (B) according to claim 27, characterized in that said transversal cutting means (11) comprise at least one blade holder cylinder (112) with at least two half-blades (112a, 112b), staggered by 180°, wherein a first half-blade (112a) is suited to make said transversal cutting of the relative row of bags (B) in a staggered position with respect to the transversal cutting made by said second half-blade (112b) on the second row of bags (B).
